(19) United States
(12) Patent Application Publication
(10) Pub. No.: US 2021/0072278 A1
(43) Pub. Date: Mar. 11, 2021

(54) HIGH-PRECISION INERTIAL MEASUREMENT APPARATUS AND INERTIAL MEASUREMENT METHOD

(71) Applicant: ACEINNA Transducer Systems Co., Ltd., Wuxi (CN)

(72) Inventors: Mike Horton, Wuxi (CN); Shu Wang, Wuxi (CN)

(73) Assignee: ACEINNA Transducer Systems Co., Ltd., Wuxi (CN)

(21) Appl. No.: 17/017,713

(22) Filed: Sep. 11, 2020

(30) Foreign Application Priority Data
Sep. 11, 2019 (CN) 201910859348.9

(51) Int. Cl. G01P 15/02; G01P 15/18; G01P 15/14

(52) U.S. Cl. CPC G01P 15/02; G01P 15/14; G01P 15/18

(57) ABSTRACT

The present invention provides an inertial measurement apparatus and an inertial measurement method. The inertial measurement apparatus includes: a plurality of inertial sensors each configured for outputting an inertial sensing signal; and a processing unit configured for detecting whether each of the inertial sensors is abnormal by analyzing the inertial sensing signal of each of the inertial sensors. The plurality of inertial sensors is used and the abnormal inertial sensor is ignored when the inertial sensing signals of the inertial sensors are processed in real time, so that a high-precision inertial sensing signal can be obtained.

### RELATED APPLICATION

This application claims the priority from CN Application having serial number 201910859348.9, filed on Sep. 11, 2019, which are incorporated herein by reference for all purposes.

### FIELD OF THE INVENTION

The present invention relates to the field of inertial measurement, and in particular to an apparatus and a method for high-precision inertial measurement with a fault tolerant mechanism.

### BACKGROUND TECHNIQUE

An inertial measurement unit (IMU) is an electronic device that measures and reports an acceleration, an angular rate, and sometimes a magnetic field surrounding a body thereof, using a combination of accelerometers and gyroscopes, sometimes also magnetometers.

As shown in FIG. 1, the IMU detects a linear acceleration through one or more accelerometers, and detects a rotation rate through one or more gyroscopes. Some IMUs further include a magnetometer usually used as a heading reference. One accelerometer and one gyroscope are configured for each of three axes (a pitch, a roll, and a yaw, X, Y, Z). In one implementation, the IMU includes at least one 3-axis accelerometer and at least one 3-axis gyroscope. Optionally, the IMU may further include at least one 3-axis magnetometer. In addition, the IMU may be further coupled to a GPS and/or other sensors. The IMU can directly or indirectly estimate a position and an orientation. In another implementation, the IMU communicates with a vehicle to control steering, stability, or balance of the vehicle.

As shown in FIG. 2, the IMU can estimate its orientation and position according to an angular velocity signal and an acceleration signal that it receives. The IMU estimates or updates the orientation by accumulating or integrating the angular velocity signals. The IMU estimates or updates the position according to the estimated orientation and the acceleration signal. There are at least four stages during the process of estimating the position of the IMU. The IMU first uses the estimated orientation and the acceleration signal to project the acceleration signal onto a global axis. Then, the IMU corrects the projected acceleration signal according to gravity and generates a global acceleration signal. The IMU can estimate the velocity according to the generated global acceleration signal and an initial velocity. Finally, the IMU can estimate and update the position according to the estimated velocity and an initial position.

However, the inertial sensing signal obtained by the IMU become inaccurate after one inertial sensor in the IMU drifts, produces an error, or freezes, and it cannot be compensated by subsequent various algorithm processing. Therefore, it is necessary to propose a high-precision inertial measurement solution with a fault-tolerant mechanism.

### SUMMARY OF THE INVENTION

This section is for the purpose of summarizing some aspects of the present invention and to briefly introduce some preferred embodiments. Simplifications or omissions in this section as well as in the abstract may be made to avoid obscuring the purpose of this section and the abstract. Such simplifications or omissions are not intended to limit the scope of the present invention.

One objective of the present invention is to provide an inertial measurement apparatus and an inertial measurement method with a fault-tolerant mechanism, so that a high-precision inertial sensing signal can be obtained.

In order to achieve the objective of the present invention, according to one aspect of the present invention, the present invention provides an inertial measurement apparatus, comprising: a plurality of inertial sensors each configured for outputting an inertial sensing signal; and a processing unit configured for detecting whether each of the inertial sensors is abnormal by analyzing the inertial sensing signal of each of the inertial sensors.

According to another aspect of the present invention, the present invention provides an inertial measurement method, comprising: obtaining a plurality of inertial sensing signals through a plurality of inertial sensors; and detecting whether each of the inertial sensors is abnormal by analyzing the inertial sensing signal of each of the inertial sensors.

In the present invention, the plurality of inertial sensors is used and the abnormal inertial sensor is ignored when the inertial sensing signals of the inertial sensors are processed, so that a high-precision inertial sensing signal can be obtained. A fault detection is performed for each of the inertial sensors to obtain the abnormal inertial sensor in real time which is excluded during subsequent processing.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will be better understood with regard to the following description, appended claims, and accompanying drawings where:

FIG. 1 is a schematic principle diagram of a conventional IMU;

FIG. 2 is a principle diagram showing a conventional IMU for estimating an orientation and a position;

FIG. 3 is a structural diagram showing an inertial measurement apparatus according to one embodiment of the present invention;

FIG. 4 is a schematic diagram showing a working principle of the inertial measurement apparatus according to one embodiment of the present invention;

FIG. 5 is a flowchart showing an inconsistent detection according to one embodiment of the present invention; and

FIG. 6 is a schematic diagram showing a principle structure of a capacitive accelerometer according to one embodiment of the present invention.

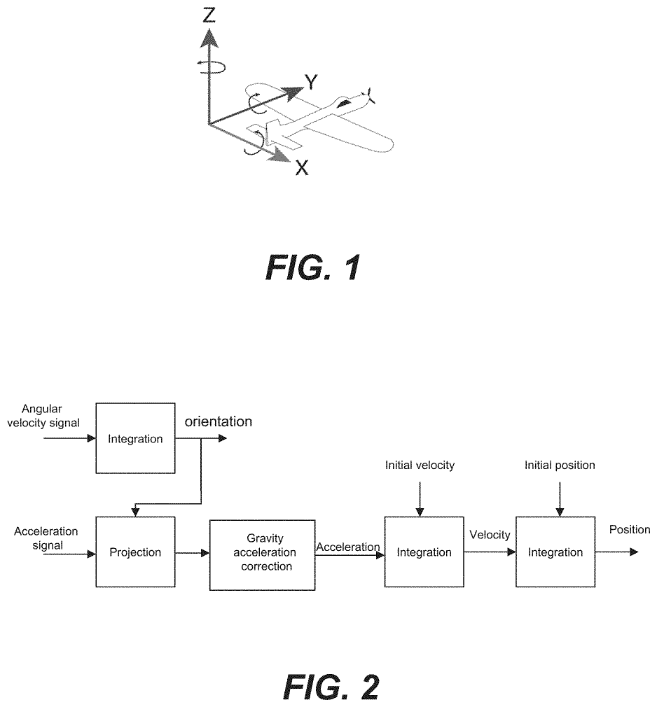

### DETAILED DESCRIPTION OF THE INVENTION

The detailed description of the invention is presented largely in terms of procedures, steps, logic blocks, processing, and other symbolic representations that directly or indirectly resemble the operations of communication or storage devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

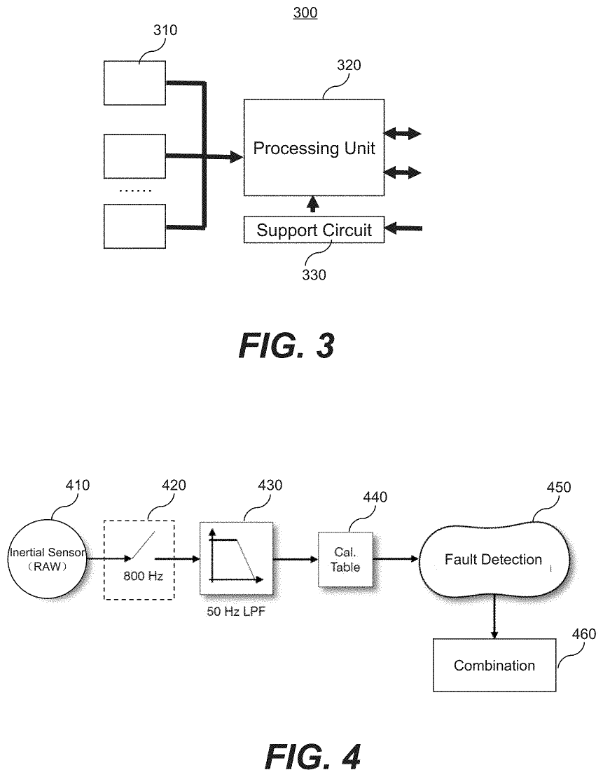

The present invention provides an inertial measurement apparatus with fault-tolerant mechanism, so that a high-precision inertial sensing signal can be obtained. FIG. 3 is a structural diagram showing an inertial measurement apparatus 300 according to one embodiment of the present invention.

As shown in FIG. 3, the inertial measurement apparatus 300 includes a plurality of IMUs 310, a processing unit 320 and a support circuit 330.

Three IMUs 310 are shown as an example in FIG. 3. Actually, two, three, four or more IMUs 310 may be disposed according to requirement. These IMUs 310 are referred to as an inertial measurement array. Each IMU 310 includes one 3-axis accelerometer and one 3-axis gyroscope. Optionally, the IMU 310 further includes at least one 3-axis magnetometer. In some embodiments, each IMU 310 may also include one or more single-axis accelerometers and/or one or more gyroscopes according to requirement. The 3-axis accelerometer can obtain acceleration signals of three axes in a working state, and the 3-axis gyroscope can obtain angular velocity signals of three axes in a working state. The accelerometer, the gyroscope, and the magnetometer all are referred to as inertial sensors.

The processing unit 320 may be a micro processing unit (MCU). The processing unit 320 is supported by the support circuit 330 and provides various interfaces, such as UART and SPI interfaces. The SPI or UART interface provides open connections to various host platforms. The IMU 310 is individually or jointly coupled to the processing unit 320, and provides inertial sensing signals to the processing unit 320. The processing unit 320 coordinates and controls the three IMUs and host a good portion of the signal processing load. In one embodiment, the processing unit 320 includes several logic units which can perform digital signal filtering, sensing data enhancement processing, and the like.

The support circuit 330 provide a combination of power, frequency, storage, clock function to the processing unit 320. The support circuit 330 has a power input of 3.5 volts. The power input is provided though an alternating current-direct current (AC-DC) adapter or a battery. In one embodiment, the inertial measurement apparatus further includes an analog front end configured to filter and digitize the inertial sensing signal output for processing by the logic unit of the processing unit 320.

FIG. 4 is a schematic diagram showing a working principle of the inertial measurement apparatus according to one embodiment of the present invention. An inertial sensor 410 shown in FIG. 4 may be one inertial sensor in the IMU 310 in FIG. 3, such as one accelerometer or one gyroscope. The inertial sensor 410 outputs a raw inertial sensing signal. Then, the raw inertial sensing signal is sequentially subjected to conventional processing such as sampling 420, filtering 430, and calibration 440. Different from the prior art, an additional fault detection 450 is added herein to detect and mark one or more abnormal inertial sensors. In this way, during subsequent combination operation 460, the inertial sensing signals of the abnormal inertial sensors can be removed, and only the inertial sensing signals output by the normal inertial sensors can be combined and processed. It should be noted that the inertial sensor passing the fault detection successively is determined to be normal and called as normal inertial sensor, and the inertial sensor being failed to pass the fault detection is determined to be abnormal and called as abnormal inertial sensor. In one embodiment, the inertial sensing signals of the normal inertial sensors are averaged to reduce noise during the combination operation 460. The sampling, the filtering, and the calibration may be implemented in the processing unit 320, or may be implemented in the IMU 310. The fault detection and the combination operation may be processed by the processing unit 320. Because a plurality of inertial sensors of a same type, such as a plurality of accelerators, are used, even if one or more of the inertial sensors are abnormal, a high-precision inertial sensing signal can be obtained according to the inertial sensing signals output by the normal inertial sensor by ignoring the inertial sensing signal of the abnormal inertial sensor. Because interference of the abnormal inertial sensor is eliminated in time, accuracy of the inertial sensing signal finally obtained can be improved. During measurement of the inertial measurement apparatus, the fault detection is performed in real time, and the abnormal inertial sensor is excluded in time, so that the real-time high-precision inertial sensing signal can be obtained.

In one embodiment, the fault detection is independently performed for each type of the inertial sensors. Specifically, the fault detection is independently performed for each axis of the 3-axis accelerometers and/or the 3-axis gyroscopes. If one axis of one 3-axis accelerometer fails during the fault detection, it is determined that the 3-axis accelerometer is abnormal, and the inertial sensing signals of other axes are ignored or excluded during subsequent processing.

The fault or abnormality of the inertial sensors usually includes a stuck fault or abnormality and an inconsistency fault or abnormality. The stuck fault may be that output of one inertial sensor is fixed near a specified value (such as 0, a minimum value, or a maximum value). The inconsistency fault may be that output of one inertial sensor greatly differs from output of other inertial sensors. Preferably, the processing unit 320 performs a stuck detection for the inertial sensors when the number of normal inertial sensors is less than or equal to 2, and the processing unit 320 perform the inconsistency detection for the inertial sensors when the number of normal inertial sensors is greater than or equal to 3. In one embodiment, the stuck detection can also be performed when the number of normal inertial sensors is greater than or equal to 3. The stuck detection can run independently with the inconsistency detection, that is, the inconsistency detection and the stuck detection can be performed simultaneously. The inconsistency detection requires at least 3 or more normal inertial sensors to be performed.

The processing unit 320 compares the inertial sensing signal of one inertial sensor with the inertial sensing signal of each of all others of the inertial sensors to determine whether the one inertial sensor is inconsistent. If output of one inertial sensor greatly differs from output of other inertial sensors, it is determined that the one inertial sensor is inconsistent. The processing unit 320 marks the inconsistent inertial sensor, and the inconsistent inertial sensor is excluded during subsequent processing such as the fault detection and the combination operation.

In one embodiment, the processing unit 320 detects a running standard deviation of an inertial sensing signal of one inertial sensor to determine whether the one inertial sensor is stuck. If output of the inertial sensor is fixed and the running standard deviation is too small, for example, is fixed near 0, a minimum value, or a maximum value, it is deemed whether the inertial sensor is stuck. The processing unit 320 marks the stuck inertial sensor, and the stuck inertial sensor is excluded during subsequent processing such as the fault detection and the combination processing. It should be noted that both the stuck inertial sensor and the inconsistent inertial sensor is regarded as the abnormal inertial sensor.

The processing unit 320 obtains a fault table of the inertial sensors and update the fault table in real time. The abnormal inertial sensor and the normal inertial sensor are marked in the fault table of the inertial sensors. The processing unit 320 decides to ignore or discard the inertial sensing signal of the abnormal inertial sensor during subsequent processing based on the fault table of the inertial sensors.

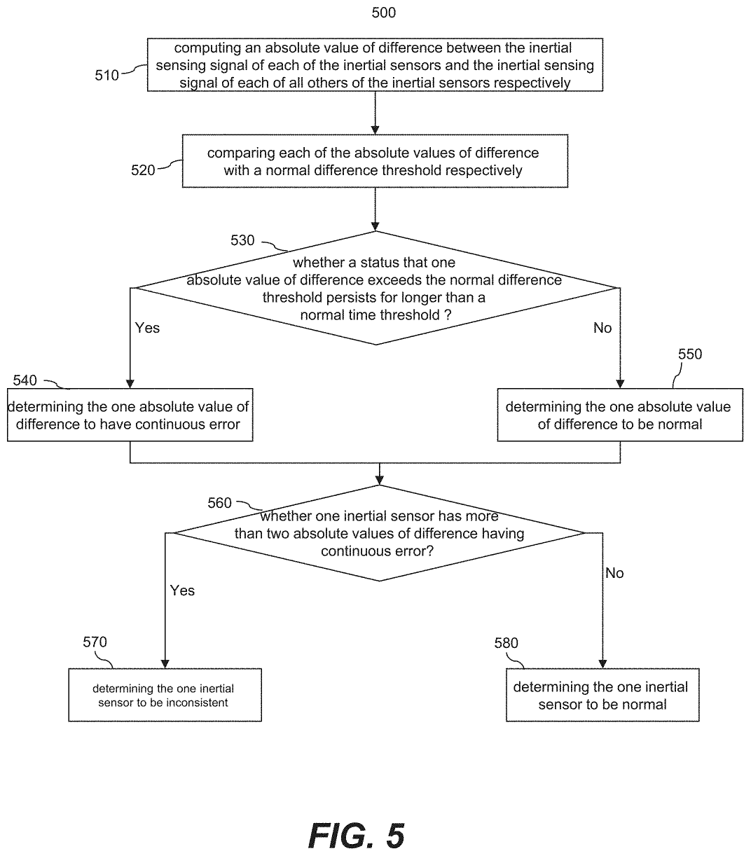

The inconsistency detection is described in detail with reference to FIG. 5 hereafter. FIG. 5 is a flowchart showing the inconsistency detection 500 performed by the processing unit 320 according to one embodiment of the present invention. It should be noted that the inconsistency detection needs to be performed for each axis of each type of the inertial sensors. Herein, x axis of the 3-axis inertial sensor is mainly used as an example for description.

At operation 510, an absolute value of difference between the inertial sensing signal of each of the inertial sensors and the inertial sensing signal of each of all others of the inertial sensors is computed respectively to obtain a plurality of absolute values of difference for each of the inertial sensors.

In one embodiment, it is assumed that the number of the normal inertial sensors is N during the inconsistency detection, and N is a natural number greater than or equal to 3. For the j^{th} inertial sensor, N−1 absolute values of difference between the inertial sensing signal of the j^{th} inertial sensor and the inertial sensing signal of each of other N−1 inertial sensors are obtained.

δ_{x,ji}=|S_{x,j}−S_{x,i}|

wherein S_{x,j} is the inertial sensing signal of the x axis of the j^{th} inertial sensor, S_{x,i} is the inertial sensing signal of the x axis of the i^{th} inertial sensor, a value of i is a value from 1 to N except for j, and δ_{x,ji} is the absolute value of difference between the inertial sensing signal of the x axis of the j^{th} inertial sensor and the inertial sensing signal of the x axis of the i^{th} inertial sensor.

For the N inertial sensors, L absolute values of difference are obtained totally:

$$L = {\sum }_{k = 1}^{N - 1} ( N - k ) .$$

The L absolute values of difference may form a matrix of (N−1)*(N−1):

$${Δ}_{x} = \vert \begin{matrix}{δ}_{x , 12} & {δ}_{x , 13} \\ - & {δ}_{x , 23}\end{matrix} \vert .$$

wherein a 2*2 matrix is provided by taking N=3 as an example herein.

At operation 520, each of the absolute values of difference is compared with a normal difference threshold limₙₒₘ respectively. In another embodiment, the absolute values of difference may also be compared with an ultra-high difference threshold lim_{high} higher than the normal difference threshold limₙₒₘ.

In one embodiment, if one absolute value of difference exceeds the normal difference threshold limₙₒₘ, a temporary mask of the one absolute value of difference is set to 0, and if one absolute value of difference exceeds the ultra-high difference threshold lim_{high}, a temporary mask of the one absolute value of difference is set to −1; otherwise, the temporary mask of the one absolute value of difference is set to 1.

$${\hat{m}}_{x , ji} = \{ \begin{matrix}- 1 , if {δ}_{x , ji} \geq {lim}_{high} \\ 0 , if {δ}_{x , ji} \geq {lim}_{nom} \\ 1 , otherwise\end{matrix}$$

wherein \hat{m}_{x,ji} is a temporary mask of one absolute value δ_{x,ji} of difference, and it can be quickly learned whether δ_{x,ji} exceeds the normal difference threshold limₙₒₘ and the ultra-high difference threshold lim_{high} according to \hat{m}_{x,ji}.

The temporary masks of all absolute values of difference are combined to form a temporary mask matrix \hat{M}ₓ:

$${\hat{M}}_{x} = \vert \begin{matrix}{\hat{m}}_{x , 12} & {\hat{m}}_{x , 13} \\ - & {\hat{m}}_{x , 23}\end{matrix} \vert ,$$

N=3 is taken as an example herein.

The normal difference threshold limₙₒₘ should account for maximum acceptable noise and bias. If one accelerometer has a bias of +2 [mg] and another accelerometer has a bias of −2 [mg], the normal difference threshold limₙₒₘ should be at least 4 [mg]. The ultra-high difference threshold lim_{high} is usually significantly greater than the normal difference threshold limₙₒₘ. If one absolute value of difference exceeds the ultra-high difference threshold lim_{high}, it means that the one absolute value of difference far exceeds the maximum acceptable noise and bias.

At 530, time counting is started when one absolute value of difference exceeds the normal difference threshold limₙₒₘ, and whether a status that the one absolute value of difference exceeds the normal difference threshold persists for longer than a normal time threshold is determined. In another embodiment, whether a status that the one absolute value of difference exceeds an ultra-high difference threshold lim_{high} higher than the normal difference threshold limₙₒₘ persists for longer than a second time threshold lower than the normal time threshold is determined. For example, the normal time threshold may be less than 100 ms, such as 50 ms, and the second time threshold may be less than the normal time threshold, for example, the second time threshold may be set to 25 ms.

In one embodiment, if a value of one temporary mask in the temporary mask matrix \hat{M}ₓ becomes 0 or −1 from 1, it means that the absolute value of difference corresponding to the one temporary mask exceeds the normal difference threshold limₙₒₘ or the ultra-high difference threshold lim_{high}, and then time counting is started by using a counter-timer.

Before the counter-timer reaches the normal time threshold, if the value of the one temporary mask becomes 1 again, that is, the corresponding absolute value of difference becomes less than the normal difference threshold again, the counter-timer is reset. When the counter-timer reaches the normal time threshold, if the value of the one temporary mask continues to be 0 or −1, that is, the corresponding absolute value of difference continues to exceed the normal difference threshold, it is determined that the one absolute value of difference has a continuous error at operation 540. In this case, a persistent mask of the one absolute value of difference is to 0, it indicates that the fault detection fails. Once the persistent mask of the absolute value of difference is set to 0, the persistent mask is not changed back to 1 subsequently unless the inertial measurement apparatus is restarted or reset. Before the counter-timer reaches the normal time threshold, if the value of the temporary mask jumps to 1 or continues to be 1, that is, the corresponding absolute value of difference does not exceed the normal difference threshold, it is determined that the absolute value of difference is normal at operation 550. In this case, the persistent mask of the absolute value of difference remains at 1, it indicates that the fault detection succeeds.

In an example,

$${M}_{x} = \vert \begin{matrix}{m}_{x , 12} & {m}_{x , 13} \\ - & {m}_{x , 23}\end{matrix} \vert$$

wherein Mₓ is a persistent mask matrix, and m_{x,12} is the persistent mask of the absolute value of difference between the inertial sensing signals of the x axe of first inertial sensor and the inertial sensing signals of the x axe of the second inertial sensors. Herein, N=3 is still used as an example for description.

At 560, whether one inertial sensor has more than two absolute values of difference having continuous error is determined. If yes, it is determined that the one inertial sensor is inconsistent at operation 570. If no, it is determined that the inertial sensor is normal at operation 580.

In one embodiment, based on the value of the persistent mask in the persistent mask matrix Mₓ, it can be quickly determined whether one inertial sensor has more than two absolute values of difference having continuous error. For an example, if m_{x,12} and m_{x,13} are 0, it means that the first inertial sensor has more than two absolute values of difference having continuous error, and it is determined that the first inertial sensor is inconsistent. For another example, if m_{x,23} and m_{x,13} are 0, it means that the third inertial sensor has more than two absolute values of difference having continuous error, and it is determined that the third inertial sensor is inconsistent. For another example, if m_{x,23} and m_{x,12} are 0, it means that the second inertial sensor has more than two absolute values of difference having continuous error.

In one embodiment, the inertial sensor is determined to be inconsistent if one inertial sensor has more than three, four or more absolute values of difference having continuous error when N is greater than 3.

After the inertial measurement apparatus 300 is restarted, the persistent mask matrix Mₓ is reset, and the processing unit 320 performs the fault detection for all inertial sensors again.

The following is an example of the inconsistency detection. Assuming that an angular velocity of the x axis is 0 deg/sec, signal output of x axes of three 3-axis gyroscopes are 1.2, −0.8, and 20.0 respectively.

In this case, a matrix formed by the absolute values of difference between the angular velocity signal of the x axis of each 3-axis gyroscope and the angular velocity signal of the x axis of each of other 3-axis gyroscopes:

$${Δ}_{x} = \vert \begin{matrix}2.0 & 18.8 \\ - & 20.8\end{matrix} \vert$$

Assuming that the normal difference threshold limₙₒₘ is 10.0 deg/sec, the temporary mask matrix \hat{M}ₓ is:

$${\hat{M}}_{x} = \vert \begin{matrix}1 & 0 \\ - & 0\end{matrix} \vert$$

If the temporary mask being 0 in the temporary mask matrix \hat{M}ₓ persists for longer than the normal time threshold, it is determined that the third 3-axis gyroscope has an inconsistent fault. The angular velocity signal of the third 3-axis gyroscope is excluded or ignored during subsequent processing. It should be noted that if one axis (such as the x axis) of one 3-axis gyroscope fails on the fault detection, it is determined that the 3-axis gyroscope is abnormal or error, and the angular velocity signals of other axes are ignored during subsequent processing.

The foregoing is described by using the inertial measurement apparatus as an example. Obviously, the present invention may also be implemented as an inertial measurement method. The inertial measurement method including: obtaining a plurality of inertial sensing signals through a plurality of inertial sensors; and detecting whether each of the inertial sensors is abnormal by analyzing the inertial sensing signal of each of the inertial sensors. An inertial sensing signal of the abnormal inertial sensor is ignored when the inertial sensing signals of the plurality of inertial sensors are processed.

In one embodiment, whether each of the inertial sensors is inconsistent is detected by comparing the inertial sensing signal of each of the inertial sensors against the inertial sensing signals of each of all others of the inertial sensors, and the inconsistent inertial sensor is ignored when the inertial sensing signals of the inertial sensors are processed. Whether each of the inertial sensors is stuck is detected by analyzing a running standard deviation of the inertial sensing signal of each of the inertial sensors, and the stuck inertial sensor is ignored when the inertial sensing signals of the inertial sensors are processed. The stuck detection is performed for each of the inertial sensors when the number of the normal inertial sensors is less than or equal to 2, and the consistency detection is performed for each of the inertial sensors when the number of the normal inertial sensors is greater than or equal to 3.

The following operations are performed during the inconsistency detection: computing an absolute value of difference between the inertial sensing signal of each of the inertial sensors and the inertial sensing signal of each of all others of the inertial sensors respectively such that a plurality of absolute values of difference is obtained for each of the inertial sensors; comparing each of the absolute values of difference with a normal difference threshold respectively and starting time counting when one absolute value of difference exceeds the normal difference threshold; determining the one absolute value of difference to have continuous error if a status that the one absolute value of difference exceeds the normal difference threshold persists for longer than a normal time threshold, and determining one inertial sensor to be inconsistent wherein if the one inertial sensor has more than two absolute values of difference having continuous error.

For other specific technical details of the inertial measurement method, please refer to the related descriptions of the inertial measurement apparatus.

One of advantages, benefits, or features of the present invention is: 1) a plurality of same type of inertial sensors are used, so that even if one or more of the inertial sensors are abnormal, a high-precision inertial sensing signal can be obtained since there are still some normal inertial sensors; 2) the real-time fault detection can be used in the present invention to find the abnormal inertial sensor in time and to exclude the abnormal inertial sensor from calculation during operating of the inertial measurement apparatus, thereby improving accuracy of an output signal, on the contrary, a self-detection is usually performed on the inertial sensors only during powering on, and no other detection is performed during operating of the inertial sensors; and 3) not simply a voting election, but a statistical mechanism is used in the present invention.

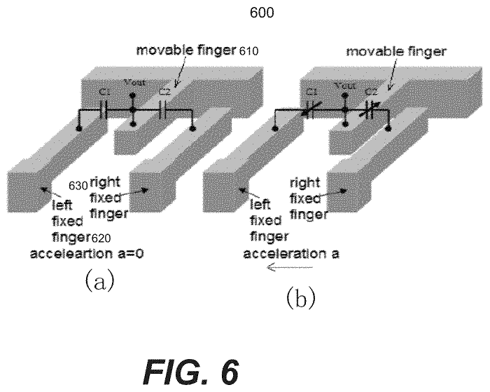

FIG. 6 is a schematic diagram showing a principle structure of a capacitive accelerometer according to the present invention. FIG. 6(a) is a state in which the acceleration a=0, and FIG. 6(b) is a state in which there is the acceleration in a direction of arrow.

As shown in FIG. 6(a), a capacitive accelerometer 600 includes a first fixed beam (left fixed finger) 620, a second fixed beam (right fixed finger) 630, and a movable mass (Moveable finger) 610. The movable mass 610 is partially located between the first fixed beam 620 and the second fixed beam 630, a first capacitor C1 is formed between the movable mass 610 and the first fixed beam 620, a second capacitor C2 is formed between the movable mass 610 and the second fixed beam 630, and the movable mass 610 is connected to a spring.

As shown in FIG. 6(b), when there is an acceleration, the movable mass 610 moves, the first capacitor C1 changes, and the second capacitor C2 also changes.

However, if the large movement comes such as from a shock or collision, the movable mass 610 moves beyond a normal movement range. Therefore, the movable mass 610 may be “stuck” with the fixed beam 620 or 630. The movable mass sticks due to the attraction and stops working. The movable mass may be “stuck” with the fixed beam due to electrostatic charge and molecular forces (Van der Waals, Hydrogen bonding). It is made worse by higher sensitivity (lower spring constant, larger capacitance area). This stiction is most likely experienced either during shipping or assembly line. Some processes better than others (but all have some level of stiction).

The MEMS stiction can be countered by having stronger springs but this reduces the sensitivity of the sensor. A solution to increase the sensitivity could be to increase the movable mass but this results in a greater surface area for the movable mass and so, unfortunately, more attractive forces.

In addition to stiction, the sensors may have significant output drift due to temperature, shock, or aging effects. Without the aforementioned detection and error elimination methods, theses errors may go undetected. A small undetected error may quickly lead to a safety hazard. For example, in the case of an autonomous vehicle using an IMU for control a 0.1G error that goes undetected for 1 s can lead to 1 m error, and if undetected for 10 s can cause a 100 m error. Autonomous vehicles are generally required to keep errors below 0.3 m at all times for safe operation.

Automatic driving based on the above inertial detection apparatus can make a position error caused by the accelerometer or the gyroscope less than 1 cm.

In the prior art, a self-test mechanism is used during powering on. These mechanisms can only detect a serious error. However, the mechanisms cannot detect a more subtle failure or error. In addition, they are not fault-tolerant. If the error is detected, a data system simply turns off the abnormal sensor, rendering the vehicle unusable.

The foregoing descriptions are merely preferred embodiments of the present invention and are not intended to limit the present invention. Any modification, equivalent replacement, and improvement made without departing from the spirit and principle of the present invention shall fall within the protection scope of the present invention.

While the present invention has been described with reference to specific embodiments, the description is illustrative of the invention and is not to be construed as limiting the invention. Various modifications to the present invention can be made to the preferred embodiments by those skilled in the art without departing from the true spirit and scope of the invention as defined by the appended claim. Accordingly, the scope of the present invention is defined by the appended claims rather than the forgoing description of embodiments.

What is claimed is:

1. An inertial measurement apparatus, comprising:
a plurality of inertial sensors each configured for outputting an inertial sensing signal; and
a processing unit configured for detecting whether each of the inertial sensors is abnormal by analyzing the inertial sensing signal of each of the inertial sensors.

2. The inertial measurement apparatus according to claim 1, wherein the abnormal inertial sensor is ignored when the inertial sensing signals of the inertial sensors are processed.

3. The inertial measurement apparatus according to claim 1, wherein the processing unit is configured for detecting whether each of the inertial sensors is inconsistent by comparing the inertial sensing signal of each of the inertial sensors against the inertial sensing signals of each of all others of the inertial sensors, and the inconsistent inertial sensor is ignored when the inertial sensing signals of the inertial sensors are processed; and/or
the processing unit is configured for detecting whether each of the inertial sensors is stuck by analyzing a running standard deviation of the inertial sensing signal of each of the inertial sensors, and the stuck inertial sensor is ignored when the inertial sensing signals of the inertial sensors are processed.

4. The inertial measurement apparatus according to claim 3, wherein the processing unit performs a stuck detection for each of the inertial sensors when the number of the normal inertial sensors is less than or equal to 2, and the processing unit performs a consistency detection for each of the inertial sensors when the number of the normal inertial sensors is greater than or equal to 3.

5. The inertial measurement apparatus according to claim 1, wherein the processing unit combines the inertial sensing signals of normal inertial sensors, outputs the combined inertial sensing signal, performs a fault detection for each of the inertial sensors to find the abnormal inertial sensor in real time, and excludes the abnormal inertial sensor during subsequent processing.

6. The inertial measurement apparatus according to claim 5, wherein the processing unit averages the inertial sensing signals of the normal inertial sensors and then outputs the averaged inertial sensing signal.

7. The inertial measurement apparatus according to claim 1, wherein a plurality of types of inertial sensors is comprised, each type of inertial sensors comprises a plurality of inertial sensors, and the processing unit performs a fault detection for each type of inertial sensors independently.

8. The inertial measurement apparatus according to claim 7, wherein one type of inertial sensors is accelerometer, and another type of inertial sensors is gyroscope.

9. The inertial measurement apparatus according to claim 8, wherein one accelerometer and one gyroscope are grouped into one inertial measurement unit, such that the plurality of accelerometers and the plurality of gyroscopes are grouped into a plurality of inertial measurement units which are called as an inertial measurement array.

10. The inertial measurement apparatus according to claim 8, wherein the accelerometer is a 3-axis accelerometer, the gyroscope is a 3-axis gyroscope, and the processing unit performs the fault detection for each axis of the 3-axis accelerometer and/or the 3-axis gyroscope independently.

11. The inertial measurement apparatus according to claim 10, wherein one 3-axis accelerometer is determined to be abnormal if one axis of the one 3-axis accelerometer fails to pass the fault detection, and the inertial sensing signals of other axes of the one 3-axis accelerometer are ignored during subsequent processing.

12. The inertial measurement apparatus according to claim 3, wherein the processing unit performs following operations during the consistency detection:
computing an absolute value of difference between the inertial sensing signal of each of the inertial sensors and the inertial sensing signal of each of all others of the inertial sensors respectively such that a plurality of absolute values of difference is obtained for each of the inertial sensors;
comparing each of the absolute values of difference with a normal difference threshold respectively and starting time counting when one absolute value of difference exceeds the normal difference threshold;
determining one absolute value of difference to have continuous error if a status that the one absolute value of difference exceeds the normal difference threshold persists for longer than a normal time threshold; and
determining one inertial sensor to be inconsistent if the one inertial sensor has more than two absolute values of difference having continuous error.

13. The inertial measurement apparatus according to claim 12, wherein one absolute value of difference is determined to have continuous error if a status that the one absolute value of difference exceeds an ultra-high difference threshold higher than the normal difference threshold persists for longer than a second time threshold lower than the normal time threshold.

14. The inertial measurement apparatus according to claim 12, wherein a counter-timer starts time counting when one absolute value of difference exceeds the normal difference threshold;
the counter-timer is reset if the one absolute value of difference changes to be smaller than the normal difference threshold before the counter-timer reaches the normal time threshold; and
the one absolute value of difference is determined to have continuous error if the counter-timer reaches the normal time threshold and the one absolute value of difference still exceeds the normal difference threshold.

15. The inertial measurement apparatus according to claim 1, wherein the processing unit performs a fault detection for all of the inertial sensors again after the inertial measurement apparatus is restarted.

16. An inertial measurement method, comprising:
obtaining a plurality of inertial sensing signals through a plurality of inertial sensors; and
detecting whether each of the inertial sensors is abnormal by analyzing the inertial sensing signal of each of the inertial sensors.

17. The inertial measurement method according to claim 16, further comprising:
ignoring the abnormal inertial sensor when the inertial sensing signals of the inertial sensors are processed.

18. The inertial measurement method according to claim 16, wherein the detecting whether each of the inertial sensors is abnormal comprises:
detecting whether each of the inertial sensors is inconsistent by comparing the inertial sensing signal of each of the inertial sensors against the inertial sensing signal of each of all others of the inertial sensors; and/or
detecting whether each of the inertial sensors is stuck by analyzing a running standard deviation of the inertial sensing signal of each of the inertial sensors;
wherein the inconsistent inertial sensor or the stuck inertial sensor is ignored when the inertial sensing signals of the inertial sensors are processed, a stuck detection for each of the inertial sensors is preformed when the number of the normal inertial sensors is less than or equal to 2, and a consistency detection for each of the inertial sensors is preformed when the number of the normal inertial sensors is greater than or equal to 3.

19. The inertial measurement method according to claim 18, wherein following operations are performed during the consistency detection:
computing an absolute value of difference between the inertial sensing signal of each of the inertial sensors and the inertial sensing signal of each of all others of the inertial sensors respectively such that a plurality of absolute values of difference is obtained for each of the inertial sensors;
comparing each of the absolute values of difference with a normal difference threshold respectively and starting time counting when one absolute value of difference exceeds the normal difference threshold;
determining the one absolute value of difference to have continuous error if a status that the one absolute value of difference exceeds the normal difference threshold persists for longer than a normal time threshold;
determining one inertial sensor to be inconsistent wherein if the one inertial sensor has more than two absolute values of difference having continuous error.

20. The inertial measurement method according to claim 19, wherein one absolute value of difference is determined to have continuous error if a status that the one absolute value of difference exceeds an ultra-high difference threshold higher than the normal difference threshold persists for longer than a second time threshold lower than the normal time threshold.
